(19) United States
(12) Patent Application Publication
(10) Pub. No.: US 2016/0242067 A1
(43) Pub. Date: Aug. 18, 2016

(54) RADIO COMMUNICATION SYSTEM, RADIO COMMUNICATION TERMINAL, CONTROL METHOD OF RADIO COMMUNICATION SYSTEM, AND STORAGE MEDIUM

(71) Applicant: NEC CORPORATION, Tokyo (JP)

(72) Inventor: Tatsuo ONISHI, Tokyo (JP)

(21) Appl. No.: 15/023,814

(22) PCT Filed: Sep. 11, 2014
(86) PCT No.: PCT/JP2014/004672

§ 371 Date: Mar. 22, 2016

(30) Foreign Application Priority Data
Sep. 27, 2013 (JP) 2013-201992

(51) Int. Cl. H04W 28/02; H04W 28/12

(52) U.S. Cl. CPC H04W 28/0289; H04W 28/12

(57) ABSTRACT

In order to provide a wireless communication system capable of controlling congestion between wireless communication sections, a wireless communication system of the present embodiment has a wireless communication terminal and a wireless base station for performing wireless communication with the wireless communication terminal. The wireless base station has a transmission means for transmitting, to the wireless communication terminal, free wireless resource information, which is information pertaining to a free wireless resource of the wireless base station. The wireless communication terminal has a reception means for receiving the free wireless resource information from the wireless base station, a holding means for holding necessary wireless resource information, which is information pertaining to a wireless resource required for wireless communication when an application of the wireless communication terminal is executed, and a control means for determining, when executing the application, whether or not to start wireless communication at application execution time on the basis of the free wireless resource information and the necessary wireless resource information.

### TECHNICAL FIELD

The disclosure of the present description relates to a radio communication system, a radio communication terminal, a control method of a radio communication system, and a storage medium.

### BACKGROUND ART

With development of mobile communication systems in recent years, in particular, improvement in a transmission speed of communication or an increase in data capacity, the number of mobile multimedia services utilizing the system has a tendency to increase. However, when traffic used by the services exceeds permissible traffic of a system, congestion often occurs in a network in the system. The same thing can be said of a radio communication section between a radio communication terminal and a radio base station.

In order to suppress such congestion in a radio communication section, related mobile communication systems utilize a congestion control technique. Among them, PTL 1 discloses a radio communication system which performs autonomous congestion control of a radio terminal using congestion information based on a random access trial frequency and assignment conditions of radio channels, and the radio terminal.

Incidentally, with respect to mobile multimedia services, providers who provide OTT (Over The Top) services are gaining power with the standardization to IP (Internet Protocol) model in mobile communication systems in recent years.

OTT indicates a generic name for video or voice services or the like provided on an existing broadband network, with no participation by carriers in management or distribution of contents themselves. In case of mobile communication systems, the OTT is often provided to a radio communication terminal by an application.

Generally, when a video or voice service or the like requires, in particular, a real time communication, it is preferable to guarantee a constant communication speed. However, in mobile communication systems, a carrier providing a core network or radio base stations does not participate in management or distribution of the application even when the application especially requires a real time communication, and therefore is unable to judge only as a mere Internet access service.

With respect to a mere Internet access service, the carriers provide the service through a best-effort type communication that does not guarantee a communication speed. Therefore, in a best-effort type communication, resources on the network are insufficient when a resource required for the real time communication exceeds an available resource on a communication network, and this causes congestion.

Also in a radio communication section between a radio communication terminal and a radio base station, radio resources are insufficient upon execution of the communication when a radio resource required for the real time communication exceeds an available radio resource of a radio base station, and this causes congestion in the radio communication section.

### CITATION LIST

### Patent Literature

### [PTL 1] Japanese Laid-open Patent Publication No. 2009-147592

### SUMMARY OF INVENTION

### Technical Problem

Autonomous control with a radio communication terminal is effective against such a problem. This is because a radio communication terminal executes an application, and therefore the radio communication terminal easily grasps whether or not a real time communication is required when executing the application.

However, a radio terminal in PTL 1 does not perform control in consideration of an available radio resource of a radio base station and a radio resource required for radio communication at the time of application execution.

Therefore, the radio terminal in PTL 1 connects to a base station and requests a radio resource required for desired radio communication even in a situation in which a radio resource required for radio communication at the time of the application execution exceeds an available radio resource of the radio base station. As a result, radio resources of a radio base station are insufficient, and congestion occurs in the radio communication section.

In view of the above, one of the objects of exemplary embodiments is to provide a radio communication system which can control congestion in a radio communication section. It is to be noted that this object is merely one of a plurality of objects which exemplary embodiments disclosed herein tries to achieve. Other objects or problems, and new features will be disclosed from description of the present description or accompanying drawings.

### Solution to Problem

A radio communication system in an exemplary embodiment includes a radio communication terminal and a radio base station that performs radio communication with the radio communication terminal. The radio base station includes a transmission means for transmitting available radio resource information which is information on an available radio resource of the radio base station to the radio communication terminal, and the radio communication terminal includes a reception means for receiving the available radio resource information from the radio base station, a holding means for holding required radio resource information which is information on a radio resource required for radio communication at the time of application execution with the radio communication terminal, and a control means for determining whether or not the radio communication at the time of the application execution is to be started, on the basis of the available radio resource information and the required radio resource information when executing the application.

A radio communication terminal in an exemplary embodiment performs radio communication with a radio base station, and includes: a reception means for receiving available radio resource information which is information on an available radio resource of the radio base station from the radio base station; a holding means for holding required radio resource information which is information on a radio resource required for radio communication at the time of application execution with the radio communication terminal; and a control means for determining whether or not the radio communication at the time of the application execution is to be started, on the basis of the available radio resource information and the required radio resource information when executing the application.

A control method of a radio communication system in an exemplary embodiment includes, in a radio communication system including a radio communication terminal and a radio base station that performs radio communication with the radio communication terminal: a reception step for receiving available radio resource information which is information on a available radio resource of the radio base station; a holding step for holding required radio resource information which is information on a radio resource required for radio communication at the time of application execution with the radio communication terminal; and a control step for determining whether or not the radio communication at the time of the application execution is to be started, on the basis of the available radio resource information and the required radio resource information when executing the application.

A storage medium in an exemplary embodiment stores a program for causing a computer to execute a control method in a radio communication system that includes a radio communication terminal and a radio base station which performs radio communication with the radio communication terminal. The storage medium stores the program for causing a computer to execute: a reception step for receiving available radio resource information which is information on an available radio resource of the radio base station; a holding step for holding required radio resource information which is information on a radio resource required for radio communication at the time of application execution with the radio communication terminal; and a control step for determining whether or not the radio communication at the time of the application execution is to be started, on the basis of the available radio resource information and the required radio resource information when executing the application.

### Advantageous Effects of Invention

According to exemplary embodiments of the present invention, it is possible to provide a radio communication system which can control congestion in a radio communication section.

### BRIEF DESCRIPTION OF DRAWINGS

FIG. 1 is a drawing illustrating a configuration according to a first exemplary embodiment.

FIG. 2 is a sequence chart illustrating an operation according to the first exemplary embodiment.

FIG. 3 is a sequence chart illustrating an operation according to a second exemplary embodiment.

FIG. 4 is a drawing illustrating a configuration according to a third exemplary embodiment.

FIG. 5 is a sequence chart illustrating an operation according to the third exemplary embodiment.

FIG. 6 is a drawing illustrating a configuration according to a fourth exemplary embodiment.

FIG. 7 is a sequence chart illustrating an operation according to the fourth exemplary embodiment.

### DESCRIPTION OF EMBODIMENTS

Hereinafter, specific exemplary embodiments are described in detail with reference to drawings. In each drawing, the same signs are given to the same elements or elements corresponding to each other, and descriptions which overlap each other are omitted as needed for the sake of clarification of description.

A plurality of exemplary embodiments described below can be implemented independently or in combination, as appropriate, with each other. A plurality of these exemplary embodiments have new features which are different from each other. Therefore, a plurality of these exemplary embodiments contribute to solving different objects or problems each other, and contribute to achieving different effects each other.

### First Exemplary Embodiment

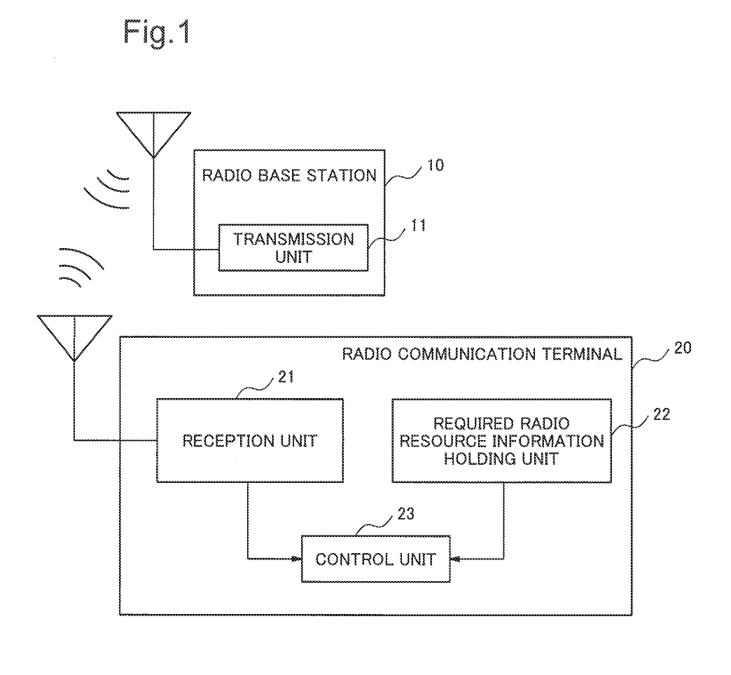

FIG. 1 is a drawing illustrating an example of a configuration of a radio communication system according to a first exemplary embodiment. In the drawing, a radio communication system includes a radio base station 10 and a radio communication terminal 20, and the radio base station 10 can perform radio communication with the radio communication terminal 20. The radio base station 10 is communicatively connected with a core network (not illustrated).

The radio base station 10 includes a transmission unit 11 as a transmission means. The radio communication terminal 20 includes a reception unit 21 as a reception means, a required radio resource information holding unit 22 as a holding means, and a control unit 23 as a control means.

Note that FIG. 1 illustrates, in particular, components relevant to the present exemplary embodiment among functional blocks included in the radio base station 10 and the radio communication terminal 20. In other words, the radio base station 10 includes functional blocks (not illustrated) for causing the radio base station 10 to function as a radio base station. Similarly, the radio communication terminal 20 includes functional blocks (not illustrated) for causing the radio communication terminal 20 to function as a radio communication terminal.

The transmission unit 11 of the radio base station 10 transmits available radio resource information which is information on an available radio resource of the radio base station 10 to the radio communication terminal 20. The reception unit 21 receives the available radio resource information transmitted from the transmission unit 11. The required radio resource information holding unit 22 holds required radio resource information which is information on a radio resource required for the radio communication at the time of application execution of the radio communication terminal 20. The control unit 23 determines whether or not the radio communication at the time of application execution is to be started on the basis of the available radio resource information and the required radio resource information when executing an application.

In the present exemplary embodiment, the application includes web browsing, download or streaming reproduction of a voice, an image, and a video, a voice communication service utilizing VoIP (Voice over IP), and an online game, for example.

The available radio resource information is, more specifically, information on a radio resource of the radio communication section between the radio base station and the radio communication terminal, and the radio resource not assigned by the radio base station at a certain point in time.

On the other hand, the required radio resource information is, more specifically, information on a radio resource required to ensure the desired communication speed of data communication used in an application execution.

The radio resource is, when the radio communication system is based on an LTE (Long Term Evolution) system, a resource block which is a minimum unit of radio resource assignment in a frequency direction, a subframe which is a minimum unit of radio resource assignment in a time direction, a resource element which is an element constituting the resource block and which is a fundamental unit to be modulated individually, or the like.

In other words, the information on the radio resource is, for example, the number of resource blocks, a position in the frequency direction, or the like when the radio resource is a resource block.

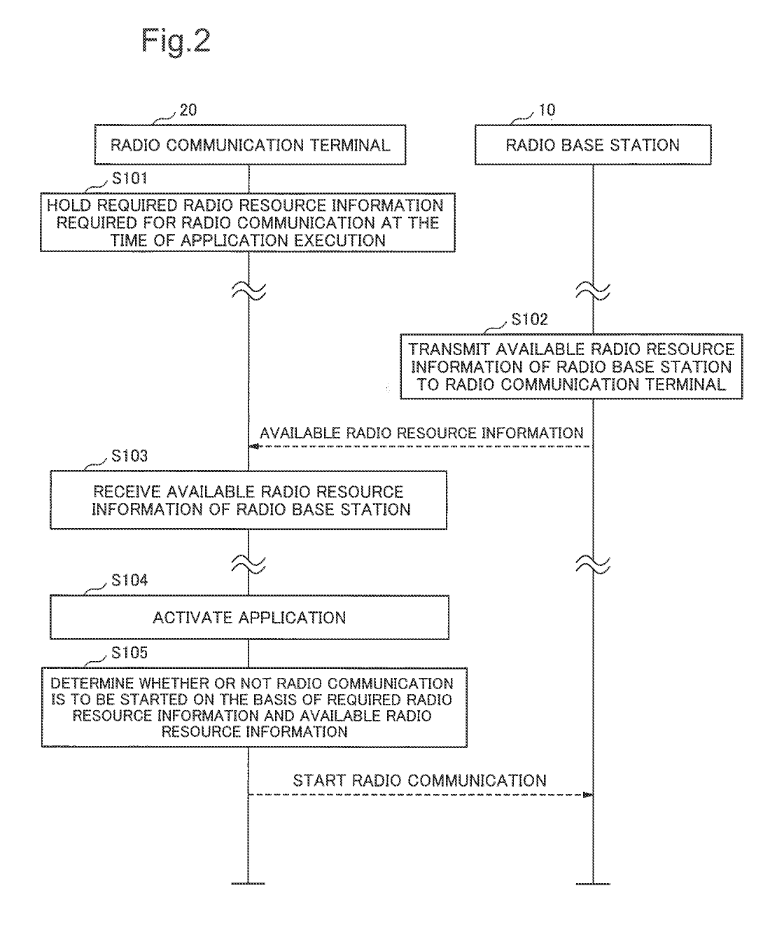

FIG. 2 is a sequence chart illustrating an example of an operation of the radio communication system according to the first exemplary embodiment. Hereinafter, operations of the radio base station 10 and the radio communication terminal 20 will be described with reference to FIG. 2.

The required radio resource information holding unit 22 of the radio communication terminal 20 holds the required radio resource information which is information on a radio resource required for the radio communication at the time of application execution (step S101).

Here, the required radio resource information holding unit 22 may determine and hold the required radio resource information on the basis of the information on a radio resource used in previous radio communication by an application.

More specifically, the required radio resource information holding unit 22 holds, at the time of application installation, the required radio resource information i₀ which is information on a radio resource required for the radio communication at the time of application execution, as an initial value. Then, the control unit 23 performs below-described control using required radio resource information iₙ₋₁ at the time of the n-th application execution after the installation (n>0 and n is an integer). When radio communication at the time of the n-th application execution is finished, the required radio resource information holding unit 22 may hold the information on the radio resource used in the actual radio communication as the required radio resource information iₙ.

In FIG. 2, the transmission unit 11 of the radio base station 10 transmits the available radio resource information of the radio base station 10 to the radio communication terminal 20 (step S102). The reception unit 21 of the radio communication terminal 20 receives the available radio resource information (step S103). Note that, for example, the available radio resource information may be transmitted in the notification information for notifying to the radio communication terminal 20 which is under the control of the radio base station 10.

Note that the operations of steps S102 and S103 may be executed a plurality of times at arbitrary timings. The interval of the executions may be constant or random.

The radio communication terminal 20 activates an application in response to operation by a user (step S104).

After activating the application, the control unit 23 determines whether or not radio communication at the time of application execution is to be started on the basis of the available radio resource information received by the reception unit 21 and the required radio resource information held by the required radio resource information holding unit 22 (step S105).

Specifically, the control unit 23 acquires the available radio resource information and the required radio resource information from the reception unit 21 and the required radio resource information holding unit 22, respectively. After that, the control unit 23 determines whether or not a radio resource of the radio base station 10 has a sufficient available radio resource required for the radio communication at the time of application execution, on the basis of the acquired available radio resource information and required radio resource information.

When the radio resource of the radio base station 10 has the sufficient available radio resource, the control unit 23 starts the radio communication to the radio base station 10. When the radio resource does not have the sufficient available radio resource, the control unit 23 does not start the radio communication to the radio base station 10. Note that, when the radio communication at the time of application execution is not to be started, the control unit 23 may notify to the application that the radio communication is not to be started, or may notify that the application is terminated.

When executing the application, the radio communication system according to the present exemplary embodiment determines whether or not the radio communication at the time of application execution is to be started on the basis of the available radio resource information and the required radio resource information. When the radio communication at the time of application execution is not started on the basis of the determination, the radio communication terminal does not request a radio resource to the radio base station, and therefore it is possible to avoid a radio resource insufficiency in the radio base station. Accordingly, congestion in the radio communication section is controllable.

As described above, according to the present invention, it is possible to provide the radio communication system which can control the congestion in the radio communication section.

### Second Exemplary Embodiment

In a radio communication system according to a second exemplary embodiment, when the control unit 23 in the first exemplary embodiment determines that radio communication at the time of application execution is not to be started, a determination is performed again after the elapse of a predetermined period of time.

The radio communication system according to the second exemplary embodiment has a configuration that is the same as or similar to the system in the first exemplary embodiment illustrated in FIG. 1.

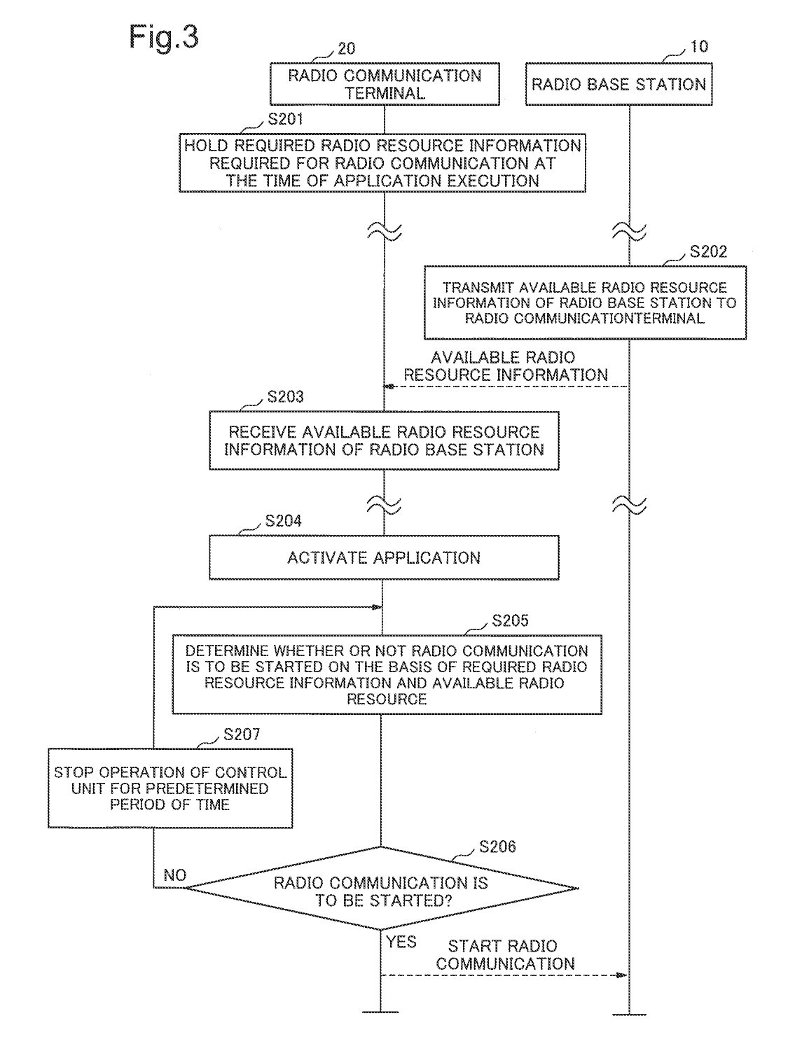

FIG. 3 is a sequence chart illustrating an example of an operation of the radio communication system according to the second exemplary embodiment. Hereinafter, operations of the radio base station 10 and the radio communication terminal 20 will be described with reference to FIG. 3. Note that the operations from steps S201 to S205 in FIG. 3 are the same as or similar to the operations from steps S101 to S105 in the first exemplary embodiment, and therefore the description is omitted.

When it is determined that the radio communication at the time of application execution is not to be started by the operation of S205 of the control unit 23 (NO in step S206), the control unit 23 stops the operation of the control unit 23 for a predetermined period of time in a state that the radio communication is not started (step S207). After the elapse of the predetermined period of time, the control unit 23 repeats the operations of steps S205 and S206. Here, the control unit 23 may include a timer therein and may measure the predetermined period of time by the timer.

When it is determined that the radio communication at the time of application execution is to be started by the operation of S205 of the control unit 23 (YES in step S206), the control unit 23 starts the radio communication to the radio base station 10.

Note that, the present exemplary embodiment may be made into an embodiment in which the control unit 23 performs the determination again at predetermined timing when it is determined that the radio communication at the time of application execution is not to be started. The predetermined timing is timing at which the reception unit 21 of the radio communication terminal 20 receives the available radio resource information of the radio base station, for example.

In the radio communication system according to the present exemplary embodiment, the control unit 23 performs the determination again after the elapse of a predetermined period of time when it is determined that the radio communication is not to be started. Therefore, in the radio communication system in the present exemplary embodiment, an opportunity to start the radio communication at the time of application execution is quickly provided by the radio communication terminal 20.

### Third Exemplary Embodiment

Due to acceptance of a massive update of an application provided by an OTT provider, there is a possibility that a big change in information on a radio resource required for radio communication at the time of the application execution may occur.

For example, when a faster communication speed is required for the data communication used at the time of the application execution due to the acceptance of an update, the radio resource required for ensuring the communication speed increases compared to the resource before the update.

Therefore, it is preferable to perform the determination by the control unit in the first exemplary embodiment on the basis of the latest information on the radio resource required for the radio communication at the time of the application execution, the information being stored in an application server which manages or distributes the application.

Thereupon, in the third exemplary embodiment, a required radio resource information holding unit 22 holds required radio resource information transmitted by an application server 40.

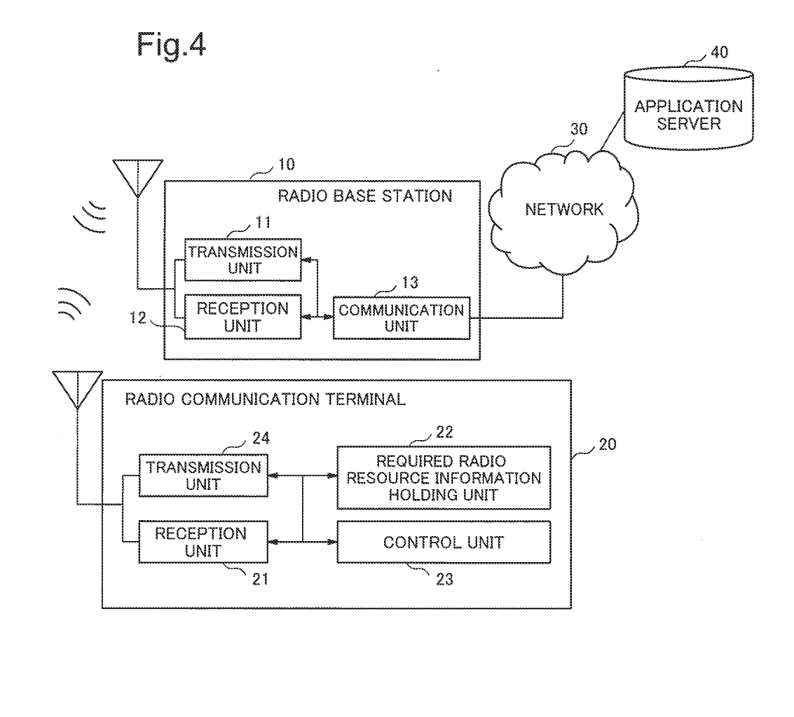

FIG. 4 is a drawing illustrating an example of a configuration of a radio communication system according to the third exemplary embodiment. In the drawing, the radio communication system is communicatively connected with the application server 40 additionally through a network 30, to the radio communication system in the first exemplary embodiment.

The network 30 is the Internet, for example, but it is not limited thereto.

To a radio base station 10 and a radio communication terminal 20 in the first exemplary embodiment, the radio base station 10 of FIG. 4 further includes a reception unit 12, and a communication unit 13, and the radio communication terminal 20 further includes a transmission unit 24.

The transmission unit 11, the reception unit 12, and the communication unit 13 of the radio base station 10 are communicatively connected one another. The reception unit 21, the required radio resource information holding unit 22, the control unit 23, and the transmission unit 24 of the radio communication terminal 20 are communicatively connected one another.

Note that the radio base station 10 and the network 30 are connected directly in the radio communication system illustrated in FIG. 4. The radio base station 10 may be connected with the network 30 through a core network and a packet gateway node, like a general radio communication system.

FIG. 4 illustrates components particularly relevant to the present exemplary embodiment among functional blocks included in the radio base station 10 and the radio communication terminal 20. In other words, the radio base station 10 includes functional blocks (not illustrated) for causing the radio base station 10 to function as a radio base station. Similarly, the radio communication terminal 20 includes functional blocks (not illustrated) for causing the radio communication terminal 20 to function as a radio communication terminal.

The control unit 23 instructs the transmission unit 24 to transmit a request message to the radio base station 10 when the radio communication at the time of application execution is started according to the determination by the control unit 23. The transmission unit 24 transmits the request message to the radio base station 10. The request message is a message for requesting the application server 40 to transmit the required radio resource information to the radio communication terminal 20.

The reception unit 12 of the radio base station 10 receives the request message from the radio communication terminal 20. The communication unit 13 transmits to and receives from the application server 40, the request message and the required radio resource information through the network 30. The transmission unit 11 transmits the required radio resource information to the radio communication terminal 20.

The reception unit 21 of the radio communication terminal 20 receives the required radio resource information from the radio base station 10, and notifies the required radio resource information holding unit 22 of the required radio resource information. The required radio resource information holding unit 22 holds the required radio resource information notified from the reception unit 21 as new required radio resource information.

The application server 40 receives the request message and transmits the required radio resource information corresponding to the message to the radio base station 10 through the network 30. Note that, in present exemplary embodiment, the application server 40 distributes the application or performs management of information on the application including information on a radio resource required for the radio communication at the time of the application execution. The application server 40 updates the required radio resource information at arbitrary timing.

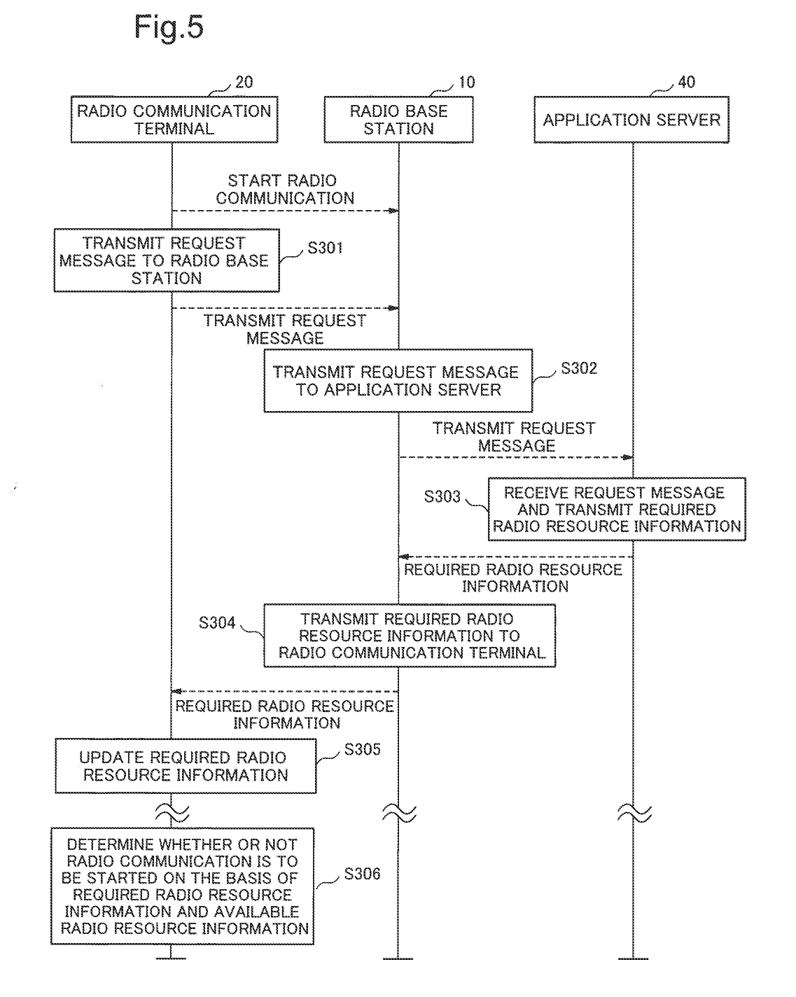

FIG. 5 illustrates a part of operations of the radio communication system and the application server 40 according to the third exemplary embodiment. FIG. 5 is a sequential chart illustrating an example of the operations when the control unit 23 determines that the radio communication at the time of application execution is to be started. In FIG. 5, operations until it is determined that the radio communication at the time of application execution is to be started are the same as or similar to the operations of the radio communication system according to the first or second exemplary embodiments, and therefore the operations are not illustrated.

Hereinafter, operations of the radio base station 10, the radio communication terminal 20, and the application server 40 will be described with reference to FIG. 5.

The control unit 23 of the radio communication terminal 20 instructs the transmission unit 24 to transmit a request message to the radio base station 10 when it is determined that the radio communication at the time of application execution is to be started. The transmission unit 24 transmits the request message to the radio base station 10 (step S301).

The reception unit 12 of the radio base station 10 receives the request message, and notifies the communication unit 13 of the message. The communication unit 13 transmits the request message to the application server 40 through the network 30 (step S302).

The application server 40 receives the request message and transmits the required radio resource information corresponding to the message to the radio base station 10 through the network 30 (step S303).

The communication unit 13 of the radio base station 10 receives the required radio resource information, and notifies the transmission unit 11 of the information. The transmission unit 11 transmits the required radio resource information to the radio communication terminal 20 (step S304).

The reception unit 21 of the radio communication terminal 20 notifies the required radio resource information holding unit 22 of the required radio resource information. The required radio resource information holding unit 22 holds the required radio resource information, which is notified, as new required radio resource information (step S305).

When newly executing an application, the radio communication terminal 20 performs the determination by the control unit 23 on the basis of the required radio resource information newly held in step S305 (step S306).

Note that, when the control unit 23 determines that the radio communication at the time of application execution is to be started, the application server 40 may transmit the required radio resource information to the radio communication terminal 20 using the start of radio communication at the time of application execution as a trigger, and the radio communication terminal 20 may receive and hold the required radio resource information.

In the radio communication system according to the present exemplary embodiment, when communication is started according to the control by the radio communication terminal, the required radio resource information holding unit 22 holds the required radio resource information transmitted from the application server as new required radio resource information. Therefore, the radio communication terminal can grasp more accurate and latest required radio resource information. As a result, it is possible to perform congestion control in the radio communication section with higher accuracy.

### Fourth Exemplary Embodiment

In a radio communication system according to a fourth exemplary embodiment, a radio communication terminal 50 receives available radio resource information and required radio resource information after establishing a radio link with a radio base station 10, and performs control of whether or not the radio communication is to be continued.

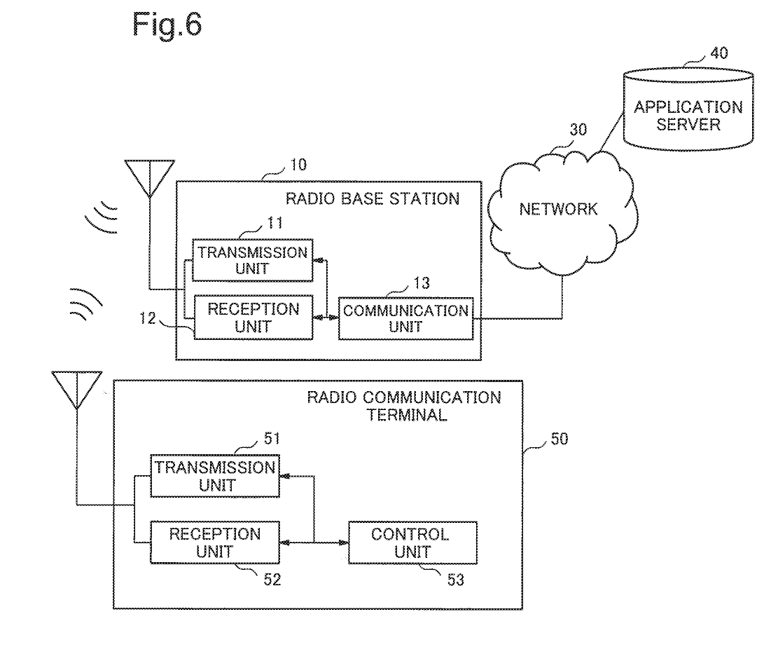

FIG. 6 is a drawing illustrating an example of the radio communication system according to the fourth exemplary embodiment. In the drawing, the radio communication system is basically the same as the radio communication system (FIG. 4) in the third exemplary embodiment, but includes the radio communication terminal 50 instead of the radio communication terminal 20 illustrated in FIG. 4. Note that the radio base station 10 can perform radio communication with the radio communication terminal 50, as is the case in the third exemplary embodiment.

The radio communication terminal 50 includes a transmission unit 51, a reception unit 52, and a control unit 53. The transmission unit 51, the reception unit 52, and the control unit 53 are communicatively connected one another.

FIG. 6 illustrates components particularly relevant to the present exemplary embodiment among functional blocks included in the radio base station 10 and the radio communication terminal 50, as is the case in FIG. 4. In other words, the radio base station 10 includes functional blocks (not illustrated) for causing the radio base station 10 to function as a radio base station. Similarly, the radio communication terminal 50 includes functional blocks (not illustrated) for causing the radio communication terminal 50 to function as a radio communication terminal.

The transmission unit 51 of the radio communication terminal 50 transmits at least one request message to the radio base station 10. The request message is a message to request to transmit available radio resource information from the radio base station 10 to the radio communication terminal 50, and a message to request to transmit required radio resource information from the application server 40 to the radio communication terminal 50.

The reception unit 52 receives the available radio resource information and the required radio resource information from the radio base station 10. The control unit 53 determines whether or not the radio communication at the time of application execution is to be continued, on the basis of the available radio resource information and the required radio resource information.

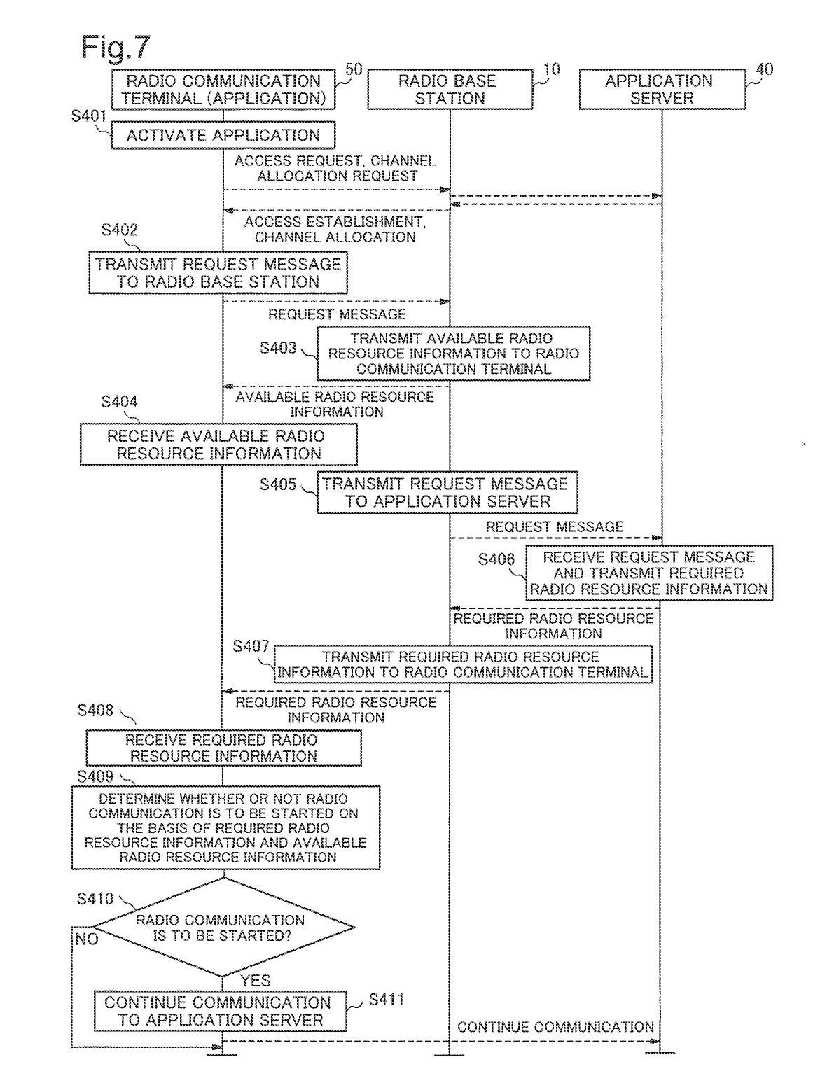

FIG. 7 is a sequence chart illustrating an example of an operation of the radio communication system according to the fourth exemplary embodiment. Note that, in FIG. 7, some of operations of the radio communication terminal 50 can be operated by an application installed in the radio communication terminal. Hereinafter, operations of the radio base station 10, the radio communication terminal 50, and the application server 40 will be described with reference to FIG. 7.

The radio communication terminal 50 activates an application in response to an operation by a user (step S401). The radio communication terminal 50 also performs a predetermined operation for establishing a communication link with the radio base station 10, the network 30, and the application server 40. The predetermined operation is, for example, a random access request, a channel allocation request, a call connection request, or the like.

According to an instruction by the application, the transmission unit 51 transmits a request message to the radio base station 10 (step S402).

The reception unit 12 of the radio base station 10 receives the request message from the radio communication terminal 50. The transmission unit 11 transmits the available radio resource information of the radio base station 10 to the radio communication terminal 50 in response to the message (step S403).

The reception unit 52 of the radio communication terminal 50 receives the available radio resource information from the radio base station 10 (step S404).

The reception unit 12 of the radio base station 10 notifies the communication unit 13 of the request message received from the radio communication terminal 50, and the communication unit 13 transmits the message to the application server 40 through the network 30 (step S405).

The application server 40 receives the request message from the communication unit 13, and transmits the required radio resource information to the radio base station 10 through the network 30 in response to the message (step S406).

The communication unit 13 of the radio base station 10 receives the required radio resource information from the application server, and notifies the transmission unit 11 of the required radio resource information. The transmission unit 11 transmits the required radio resource information, which is notified, to the radio communication terminal 50 (step S407).

The reception unit 52 of the radio communication terminal 50 receives the required radio resource information from the radio base station 10 (step S408).

Note that, in the present exemplary embodiment, the timing of transmission of the available radio resource information and the required radio resource information by the radio base station 10 is not a big issue, and therefore either one may be transmitted first or simultaneously.

The reception unit 52 notifies the control unit 53 of the received available radio resource information and required radio resource information.

The control unit 53 performs the determination whether or not the radio resource of the radio base station 10 has a sufficient available radio resource required for the radio communication at the time of application execution, on the basis of the acquired available radio resource information and required radio resource information (step S409).

When the radio resource of the radio base station 10 has the sufficient available radio resource (Yes in step S410), the radio communication to the radio base station 10 is continued (step S411), and when not (No in step S410), the radio communication to the radio base station 10 is stopped.

Note that, when the radio base station 10 does not have the sufficient available radio resource (No in step S410), it may be notified to the application that the radio communication is to be stopped, or it may be notified that the application is to be terminated. The operations of steps S402 to S410 may be performed again after the elapse of a predetermined period of time or at predetermined timing.

In the radio communication system according to the present exemplary embodiment, the radio communication terminal requires the available radio resource information and the required radio resource information after establishing the radio link between the radio base station and the radio communication terminal, and performs the determination on the basis of the information. Therefore, it is not necessary to define a new sequence in a radio communication system, and it is possible to easily apply this system to existing systems.

### Modification of Exemplary Embodiments

Various modifications can be considered in implementing the present invention, and the present invention is not limited to the above-described exemplary embodiments.

In the radio communication system of the first and second exemplary embodiments, the radio communication terminal 20 may further include a table storing at least one or more pieces of required radio resource information.

In that case, when the radio communication at the time of application execution is terminated, the radio communication terminal 20 stores information on the radio resource actually used for the radio communication by the application into the table. The required radio resource information holding unit 22 may hold a value determined on the basis of at least one or more pieces of stored information on the radio resource actually used, as the required radio resource information.

An example of a determination method is a method of calculating an average of radio resource quantities used in radio communication at the time of the past ten application executions, for example.

The required radio resource information is estimated using at least one or more pieces of information on the radio resources actually used, and therefore it becomes possible to perform more detailed congestion control.

Note that the radio communication system in which any of the exemplary embodiments mentioned above may be applicable to 3GPP LTE (Long Term Evolution), 3GPP W-CDMA (Wideband Code Division Multiple Access), GSM (registered trademark) (Global System for Mobile communications), WiMAX (Worldwide interoperability for Microwave Access), and the like, but not limited to these systems.

The radio communication system and the radio communication terminal described above can be realized by hardware, software, or a combination thereof. The control method of the radio communication system described above can be also realized by hardware, software, or a combination thereof. Here, “realized by software” means “realized by a computer that reads and executes a program”.

The program can be stored using various types of non-transitory computer readable medium to be provided into a computer. The non-transitory computer readable medium includes various types of tangible storage medium.

Examples of the non-transitory computer readable medium include a magnetic recording medium (such as a flexible disk, a magnetic tape, and a hard disk drive), an magneto-optical recording medium (such as a magneto-optical disc), a CD-ROM (Compact Disc-Read Only Memory), a CD-R (Compact Disc-Recordable), a CD-R/W (Compact Disc-Rewritable), a DVD-ROM (Digital Versatile Disc-ROM), a DVD-R (Digital Versatile Disc-Recordable), a DVD-R/W (Digital Versatile Disc-Rewritable), and a semiconductor memory (such as a mask ROM, a PROM (Programmable ROM), an EPROM (Erasable PROM), a flash ROM, and a RAM (Random Access Memory)).

In addition, the program may be provided to a computer by various types of transitory computer readable medium. Examples of the transitory computer readable medium include an electrical signal, an optical signal, and an electromagnetic wave. The transitory computer readable medium can provide a program to a computer through a wired communication path, such as an electric wire and an optical fiber, or a radio communication path.

The exemplary embodiments described above can be combined as appropriate to be implemented. The present invention is not limited to each exemplary embodiment described above, and can be implemented in various embodiments.

Note that some or all of the above-described exemplary embodiments can be described as the following supplementary notes, but not limited thereto.

### (Supplementary Note 1)

A radio communication system comprising:

a radio communication terminal; and
a radio base station configured to perform radio communication with the radio communication terminal,
wherein the radio base station includes

a transmission means for transmitting, to the radio communication terminal, available radio resource information which comprises information on an available radio resource of the radio base station, and

the radio communication terminal includes

a reception means for receiving the available radio resource information from the radio base station,

a holding means for holding required radio resource information which comprises information on a radio resource required for radio communication at application execution in the radio communication terminal, and

a control means for determining whether the radio communication at the application execution is to be started, based on the available radio resource information and the required radio resource information, at the application execution.

### (Supplementary Note 2)

The radio communication system according to Supplementary Note 1,

wherein the transmission means notifies the available radio resource information to the radio communication terminal under the radio base station.

### (Supplementary Note 3)

The radio communication system according to Supplementary Note 1 or 2,

wherein the holding means determines and holds the required radio resource information based on information on a radio resource used for previous radio communication by the application.

### (Supplementary Note 4)

The radio communication system according to any one of Supplementary Notes 1 to 3,

wherein the control means determines again, when determined that the radio communication at the application execution is not to be started, whether the radio communication at the application execution is to be started after a predetermined time has elapsed.

### (Supplementary Note 5)

The radio communication system according to any one of Supplementary Notes 1 to 3,

wherein the control means determines again, when determining that the radio communication at the application execution is not to be started, whether the radio communication at the application execution is to be started after reception of the available radio resource information by the reception means.

### (Supplementary Note 6)

The radio communication system according to any one of Supplementary Notes 1 to 3,

wherein the radio communication system is connected with an application server through a network, and

wherein the holding means holds the required radio resource information transmitted from the application server.

### (Supplementary Note 7)

A radio communication terminal configured to perform radio communication with a radio base station, the radio communication terminal comprising:

a reception means for receiving available radio resource information which comprises information on an available radio resource of the radio base station from the radio base station;

a holding means for holding required radio resource information which comprises information on a radio resource required for radio communication at application execution in the radio communication terminal; and

a control means for determining whether the radio communication at the application execution is to be started, based on the available radio resource information and the required radio resource information, at the application execution.

### (Supplementary Note 8)

The radio communication terminal according to Supplementary Note 7,

wherein the holding means determines and holds the required radio resource information based on information on a radio resource used in previous radio communication by the application.

### (Supplementary Note 9)

The radio communication terminal according to Supplementary Note 7 or 8, wherein the control means determines again, when it is determined that the radio communication at the time of the application execution is not to be started, whether or not the radio communication at the time of the application execution is to be started after the elapse of a predetermined period of time.

### (Supplementary Note 10)

A control method of a radio communication system including a radio communication terminal and a radio base station that performs radio communication with the radio communication terminal, the control method including:

a reception step for receiving available radio resource information which is information on an available radio resource of the radio base station;

a holding step for holding required radio resource information which is information on a radio resource required for radio communication at the time of application execution with the radio communication terminal; and

a control step for determining whether or not the radio communication at the time of the application execution is to be started, on the basis of the available radio resource information and the required radio resource information when executing the application.

### (Supplementary Note 11)

The control method of the radio communication system according to Supplementary Note 10, wherein the reception step receives the available radio resource information notified to the radio communication terminal under the radio base station.

### (Supplementary Note 12)

The control method of the radio communication system according to Supplementary Note 10 or 11, wherein the holding step determines and holds the required radio resource information on the basis of information on a radio resource used in previous radio communication by the application.

### (Supplementary Note 13)

The control method of the radio communication system according to any one of Supplementary Notes 10 to 12, wherein the control step determines again, when it is determined that the radio communication at the time of the application execution is not to be started, whether or not the radio communication at the time of the application execution is to be started after the elapse of a predetermined period of time.

### (Supplementary Note 14)

The control method of the radio communication system according to any one of Supplementary Notes 10 to 12, wherein the control step determines again, when it is determined that the radio communication at the time of the application execution is not to be started, whether or not the radio communication at the time of the application execution is to be started after reception of the available radio resource information by the receiving step.

### (Supplementary Note 15)

The control method of the radio communication system according to any one of Supplementary Notes 10 to 12, wherein the radio communication system is connected with an application server through a network, and the holding step holds the required radio resource information transmitted from the application server.

### (Supplementary Note 16)

A control method of a radio communication terminal performing radio communication with a radio base station, the control method including:

a reception step for receiving available radio resource information which is information on an available radio resource of the radio base station;

a holding step for holding required radio resource information which is information on a radio resource required for radio communication at the time of application execution with the radio communication terminal; and

a control step for determining whether or not the radio communication at the time of the application execution is to be started, on the basis of the available radio resource information and the required radio resource information when executing the application.

### (Supplementary Note 17)

The control method of the radio communication terminal according to Supplementary Note 16, wherein the holding step determines and holds the required radio resource information on the basis of information on a radio resource used in previous radio communication by the application.

### (Supplementary Note 18)

The control method of the radio communication terminal according to Supplementary Note 16 or 17, wherein the control step determines again, when it is determined that the radio communication at the time of the application execution is not to be started, whether or not the radio communication at the time of the application execution is to be started after the elapse of a predetermined period of time.

### (Supplementary Note 19)

A program causing a computer to implement a control method in a radio communication system including a radio communication terminal and a radio base station that performs radio communication with the radio communication terminal, the program causing a computer to execute:

a reception step for receiving available radio resource information which is information on an available radio resource of the radio base station,

a holding step for holding required radio resource information which is information on a radio resource required for radio communication at the time of application execution with the radio communication terminal, and

a control step for determining whether or not the radio communication at the time of the application execution is to be started, on the basis of the available radio resource information and the required radio resource information when executing the application.

### (Supplementary Note 20)

A program causing a computer to implement a control method of a radio communication terminal performing radio communication with a radio base station, the program causing a computer to execute:

a reception step for receiving available radio resource information which is information on an available radio resource of the radio base station;

a holding step for holding required radio resource information which is information on a radio resource required for radio communication at the time of application execution with the radio communication terminal; and

a control step for determining whether or not the radio communication at the time of the application execution is to be started, on the basis of the available radio resource information and the required radio resource information when executing the application.

### (Supplementary Note 21)

A radio communication system including a radio communication terminal and a radio base station that performs radio communication with the radio communication terminal, and connecting with an application server through a network, wherein

the radio communication terminal includes

a transmission means for transmitting a transmission request to request available radio resource information which is information on an available radio resource of the radio base station and required radio resource information which is information on a radio resource required for radio communication at the time of application execution,

a reception means for receiving the available radio resource information transmitted from the radio base station in response to the transmission request, and the required radio resource information transmitted from the application server,

a control means for determining whether or not the radio communication at the time of the application execution is to be stopped, on the basis of the available radio resource information and the required radio resource information when executing the application which are received.

### (Supplementary Note 22)

The radio communication system according to Supplementary Note 21, wherein the control means determines again, when it is determined that the radio communication at the time of the application execution is to be stopped, whether or not the radio communication at the time of the application execution is to be stopped after the elapse of a predetermined period of time.

The present application claims priority based on Japanese Patent Application No. 2013-201992, filed on Sep. 27, 2013, the entire disclosure of which is incorporated herein.

### REFERENCE SIGNS LIST

10 Radio base station
11 Transmission unit
12 Reception unit
13 Communication unit
20, 50 Radio communication terminal
21, 52 Reception unit
22 Required radio resource information holding unit
23, 53 Control unit
24, 51 Transmission unit
30 Network
40 Application server

1. A radio communication system comprising:
a radio communication terminal; and
a radio base station configured to perform radio communication with the radio communication terminal, wherein the radio base station includes
a transmission unit configured to transmit, to the radio communication terminal, available radio resource information which comprises information on an available radio resource of the radio base station, and
the radio communication terminal includes
a reception unit configured to receive the available radio resource information from the radio base station,
a holding unit configured to receive required radio resource information which comprises information on a radio resource required for radio communication at application execution in the radio communication terminal, and
a control unit configured to determine whether the radio communication at the application execution is to be started, based on the available radio resource information and the required radio resource information, at the application execution.

2. The radio communication system according to claim 1,
wherein the transmission unit, notifies the available radio resource information to the radio communication terminal under the radio base station.

3. The radio communication system according to claim 1,
wherein the holding unit determines and holds the required radio resource information based on information on a radio resource used for previous radio communication by the application.

4. The radio communication system according to claim 1,
wherein the control unit determines again, when determined that the radio communication at the application execution is not to be started, whether the radio communication at the application execution is to be started after a predetermined time has elapsed.

5. The radio communication system according to claim 1,
wherein the control unit determines again, when determining that the radio communication at the application execution is not to be started, whether the radio communication at the application execution is to be started after reception of the available radio resource information by the reception unit.

6. The radio communication system according to claim 1,
wherein the radio communication system is connected with an application server through a network, and wherein the holding unit holds the required radio resource information transmitted from the application server.

7. A radio communication terminal configured to perform radio communication with a radio base station, the radio communication terminal comprising:
a reception unit configured to receive available radio resource information which comprises information on an available radio resource of the radio base station from the radio base station;
a holding unit configured to receive required radio resource information which comprises information on a radio resource required for radio communication at application execution in the radio communication terminal; and
a control unit configured to determine whether the radio communication at the application execution is to be started, based on the available radio resource information and the required radio resource information, at the application execution.

8. A control method of a radio communication system including a radio communication terminal and a radio base station configured to perform radio communication with the radio communication terminal, the control method comprising:
receiving available radio resource information which comprises information on an available radio resource of the radio base station;
holding required radio resource information which comprises information on a radio resource required for radio communication at application execution in the radio communication terminal; and
determining whether the radio communication at the application execution is to be started, based on the available radio resource information and the required radio resource information at the application execution.

9. A non-transitory computer readable medium storing a program causing a computer to implement a control method in a radio communication system including a radio communication terminal and a radio base station configured to perform radio communication with the radio communication terminal, the program causing a computer to execute:
receiving available radio resource information which comprises information on an available radio resource of the radio base station,
holding required radio resource information which comprises information on a radio resource required for radio communication at application execution in the radio communication terminal, and
determining whether the radio communication at the application execution is to be started, based on the available radio resource information and the required radio resource information at the application execution.

10. The radio communication system according to claim 2,
wherein the holding unit determines and holds the required radio resource information based on information on a radio resource used for previous radio communication by the application.

11. The radio communication system according to claim 2,
wherein the control unit determines again, when determined that the radio communication at the application execution is not to be started, whether the radio communication at the application execution is to be started after a predetermined time has elapsed.

12. The radio communication system according to claim 3,
wherein the control unit determines again, when determined that the radio communication at the application execution is not to be started, whether the radio communication at the application execution is to be started after a predetermined time has elapsed.

13. The radio communication system according to claim 2,
wherein the control unit determines again, when determining that the radio communication at the application execution is not to be started, whether the radio communication at the application execution is to be started after reception of the available radio resource information by the reception unit.

14. The radio communication system according to claim 3,
wherein the control unit determines again, when determining that the radio communication at the application execution is not to be started, whether the radio communication at the application execution is to be started after reception of the available radio resource information by the reception unit.

15. The radio communication system according to claim 2,
wherein the radio communication system is connected with an application server through a network, and wherein the holding unit holds the required radio resource information transmitted from the application server.

16. The radio communication system according to claim 3,
wherein the radio communication system is connected with an application server through a network, and wherein the holding unit holds the required radio resource information transmitted from the application server.

17. The radio communication system according to claim 10,
wherein the control unit determines again, when determined that the radio communication at the application execution is not to be started, whether the radio communication at the application execution is to be started after a predetermined time has elapsed.

18. The radio communication system according to claim 10,
wherein the control unit determines again, when determining that the radio communication at the application execution is not to be started, whether the radio communication at the application execution is to be started after reception of the available radio resource information by the reception unit.

19. The radio communication system according to claim 10,
wherein the radio communication system is connected with an application server through a network, and wherein the holding unit holds the required radio resource information transmitted from the application server.
